(19) United States
(12) Patent Application Publication
(10) Pub. No.: US 2002/0084994 A1
(43) Pub. Date: Jul. 4, 2002

(54) Front panel serial port server user interface

(76) Inventor: Peter A. Hansen, Cypress, TX (US)

Correspondence Address: Conley, Rose & Tayon, Attention: JONATHAN M. HARRIS, P. O. Box 3267, Houston, TX, 77253-3267, US

(21) Appl. No.: 09/751,789

(22) Filed: Dec. 29, 2000

(51) Int. Cl. G09G 5/00

(52) U.S. Cl. 345/204

(57) ABSTRACT

The present invention provides an apparatus and method for accessing system status or management information for a headless high- density rack mounted computer server. The server is provided with a serial port on its front surface which provides access to the server's health management software. A small display device is provided with a mating serial port on its backside. The serial ports are positioned to mechanically support the display in a position where the display of management information may be read by a system administrator or maintenance personnel. During maintenance operations, the user plugs the display into the serial port on the front of a server to read status, then removes the display and plugs it into the next server and so on. The display may include at least one pushbutton which allows a user to send information or commands to the server.

### BACKGROUND OF THE INVENTION

1. Field of the Invention

The present invention relates to user interfaces for computer servers, and more particularly to an arrangement of a serial port and a plug-in display panel in a headless server to allow display of server information and limited inputting of information.

2. Background of the Invention

The personal computer has become standard equipment in most business offices, home offices and even “media” rooms of residences. A standard personal computer is commonly understood to include several components in addition to the “box” housing the actual computer processor. These components normally include user interface components such as a monitor, keyboard and mouse. These user interface components often require as much or more space than the box or computer processor housing itself. Each user interface component is normally connected to the computer processor by a cable plugged into a port on the back surface of the computer processor housing. In the usual residential or office application, the user interface components are essential and space is not a problem.

An increasing number of personal computers, however, are being used as servers. For example, Internet service providers may need hundreds or even thousands of servers. Websites are operated by servers. The more successful the website, the more servers it requires. While standard personal computers have the necessary computing and memory capacity to act as servers, their physical configuration is not well adapted to the application. Servers normally interface with other computers through some type of network, e.g., the Internet. Servers do not normally need user interfaces, e.g., a monitor, keyboard, etc. These interface components represent unnecessary cost and take up space. Servers are often “headless”, meaning they do not have a keyboard, mouse or monitor and often do not have a CD ROM drive or a floppy disk drive. When hundreds or thousands of servers are to be located on one premises, they need to be adapted for rack mounting to save space. To conserve space, computers designed for high-density server applications are available with a total box height of less than two inches. Rack mounting does not provide a convenient space for bulky user interface components such as the keyboard, mouse and monitor.

Most servers have status or health software which keeps track of the server operations and identifies problems which may occur. It provides a short list of information, or health management log, which is the first thing maintenance personnel need to know about a server when doing regular maintenance. While conventional user interface peripherals have more than enough functional ability to review the management logs, they require too much space and represent an unnecessary expense. However, there is a need for access to computer management logs for maintenance personnel. The access device needs to be low cost, simple, and portable and should not take up any of the limited rack mount space.

### BRIEF SUMMARY OF THE INVENTION

The present invention includes a server serial port on a rack mount computer server and a mating serial port on a display panel. The serial ports provide electrical connections to allow the display panel to display information from the server. The display panel is mechanically supported on the server when the serial ports are plugged together. In one embodiment, the panel includes one or more push buttons allowing user communication from the display to the server.

### BRIEF DESCRIPTION OF THE DRAWINGS

For a detailed description of the preferred embodiments of the invention, reference will now be made to the accompanying drawings in which:

FIG. 1 is a front view of rack mounted servers illustrating a front panel display according to the present invention;

FIG. 2 is a top view of a portion of a server and a display unit according to the present invention; and,

FIG. 3 is an isometric view of a server and a display unit according to the present invention.

### DETAILED DESCRIPTION OF THE PREFERRED EMBODIMENTS

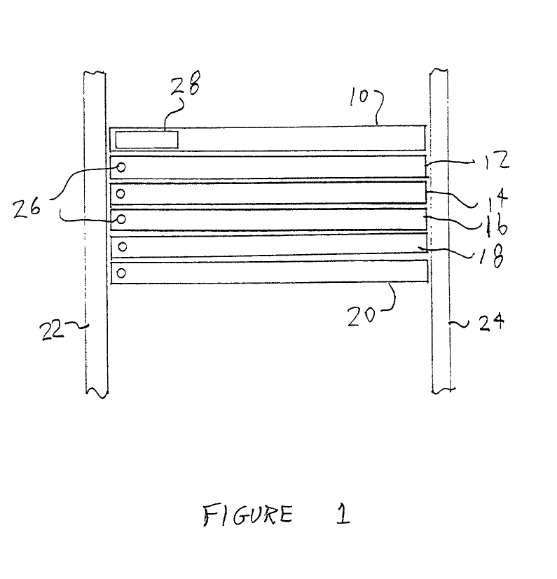

With reference to FIG. 1, there is illustrated a typical rack mounted arrangement of computer servers 10, 12, 14, 16, 18 and 20. Computers designed for this application are typically housed in simple rectangular boxes having a vertical height of 1.75 inches and a standard rack mount width of 16.75 inches. The servers 10-20 are fastened to, and supported by, rack support members 22 and 24. While only six servers 10-20 are illustrated, it is understood that a standard rack can be filled with servers from the floor level to the top of the rack. For the servers used in the preferred embodiment, a standard rack can hold up to forty-two servers.

Essentially all of the server ports or plugs for receiving wires, cables, etc. which provide power, Ethernet connections, etc. are provided on the back of rack mounted servers. If a rack is filled with forty-two servers, there are forty-two sets of these wires, cables, etc. running from the back of the rack to power outlets, Ethernet connections, etc. which are normally mounted on the surface of a wall of the room in which the servers are housed.

For headless servers, it has been common practice for installation and maintenance personnel to connect consoles to some type of port on the back of the servers in order to have a user interface. However access to the back of rack mounted systems is usually difficult. In most cases the rack is fixed to the floor and/or weighs in excess of a thousand pounds, so movement for access is not possible. Movement of the wires and cables should be limited to avoid damaging them or accidentally disconnecting them. These problems are avoided in the present invention by providing a serial port 26 on the front surface of each server 10, 12, etc. Server 10 also has a display device 28 plugged into, and mechanically supported by, its serial port which is hidden behind display 28.

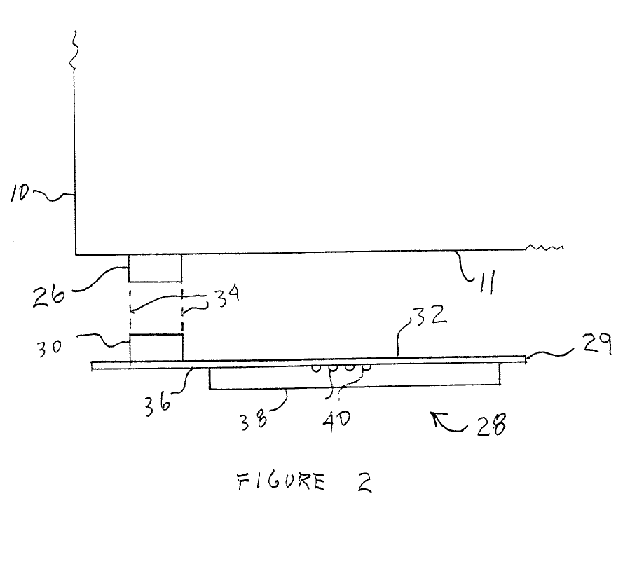

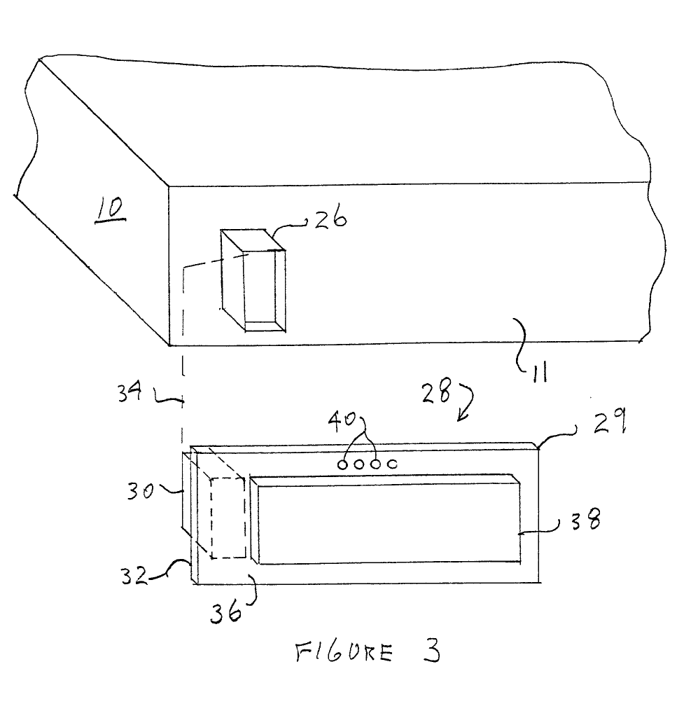

With reference to FIGS. 2 and 3, more details of the present invention are illustrated. In FIGS. 2 and 3, a portion of the front surface 11 of server 10 and its serial port 26 are shown. Display 28 is assembled on a printed circuit board 29. A serial port 30 and electronic components are mounted on the back surface 32 of board 29. Dotted lines 34 indicate that ports 26 and 30 are to be plugged together. A display unit 38 is mounted on the front surface 36 of board 29. Preferably, one or more push buttons 40 are also positioned on the front surface 36 of board 29.

The serial ports 26 and 30 may use either DB9 or RJ-45 type of plugs. Either is suitable for providing the electrical connections needed for the standard RS-232 serial interface protocol. In addition, either type of plug provides sufficient mechanical strength to support display 28 when it is plugged in. Plugs 26 and 30 are preferably matched sets of male and female connectors. In the initial trial of the invention, an off-the-shelf display with a male connector was connected with an adapter to the server plug which was also a male connector. This arrangement provided the necessary mechanical support as well as the RS-232 electrical connections.

The display device used in the initial implementation was the SKD 162-632 Intelligent Serial LCD Display available from Crystalfontz America Incorporated, 15611 East Washington Road, Valleyford, Wash. 99036 USA. It has a DB9 male connector and is designed for the standard RS 232 protocol. It provides two rows of display 96 dots long by 8 dots high. This provides about twenty letters or numbers of display on each row. This device draws the electrical power it needs from two RS 232 signal lines, the DTR, Data Terminal Ready, and RTS, Request to Send, signal lines. These lines are driven to high logic level by software in the server and the RS 232 port drivers provide sufficient current to power the display, which requires only about 5 ma of current. The overall physical dimensions of the Crystalfontz device is about 1.7×4.25×0.62 inches.

It is desirable to have one or more pushbuttons 40 on the display 28. Pushbuttons 40 may be simple single pole switches. While the Crystalfontz device does not have these buttons, the device can be polled for status of these buttons, or the firmware in the display can maintain the button state and notify its host server of the button press event. These can be used for various server management functions, such as instructing the server to start or stop displaying the health status information or for clearing management log entries displayed on the panel.

While the display 28 described herein uses a LCD, i.e., liquid crystal display, other types of display may also be used. For example, VFD, vacuum fluorescent displays, would also be suitable.

The present invention is typically used by a systems administrator or maintenance person. The display unit itself is small enough to be carried in a small brief case, tool box or even a shirt pocket. To check the status of a rack fill, or room full, of servers, the administrator simply plugs the display into the front panel serial port of the particular server, e.g., server 10, being checked. The server health software then sequentially supplies a management log or error messages to the display. Typical health information includes: fan status (e.g., OK, dead, dead but redundant, etc.); temperature (e.g., of CPU, chassis, etc.); power supply status (e.g., dead, redundant, etc.); correctable memory errors; integrated management log; automatic server recovery; and, system utilization. The administrator may quickly review this information to determine if any corrective action is needed.

In many cases, the server will be operating normally, and the administrator simply needs to note that fact and move on to the next server. The administrator then unplugs the display from the first server, e.g., server 10, and plugs it into the next, e.g., server 12, and so on. The serial port is particularly useful in this situation because it is designed for this hot plug use where it can be plugged into, and unplugged from, operating machines.

If the management log indicates there is a problem, the administrator may need to make a more robust connection to the server, e.g., through its Ethernet port, to correct the problem. But use of the present invention allows the administrator to quickly identify the problem and the server which needs repair. In case of an intermittent problem with a server, it may be desirable to leave one of the display units plugged into the serial port of that server for a period of time to simplify multiple checks on its status.

The push buttons 40 are also useful during initial installation of a server. Headless servers typically do not have CD ROM drives or even floppy disk drives which are commonly used to load operating system, OS, and applications software. Many servers are delivered without this software. Such software can be downloaded over the Internet using protocols such as the Preboot eXecution Environment, PXE, which is available from Intel Corporation. A server can be delivered with a PXE enabled ROM. Upon installation it connects to the network. The server ROM could provide a menu of available OS and applications software. The menu can also include a list of “personalities”, e.g., personal computer or web server, for which the PXE server knows the required OS and/or applications software. When selections are made from the menu, the PXE server knows how to locate and download the software from the Internet. However, a user interface is required for the installer to make the necessary selections from the menu. The present invention provides a simple way for the installer to designate preferences or personalities, which the PXE system can then use to request and download the appropriate software. For example, the installer can use the push buttons to scroll through the menu and select Windows 2000 as the OS software and designate the personality of the computer as a Web Server, which will automatically identify the necessary applications software.

While the present invention has been illustrated and described in terms of particular apparatus and methods of use, it is apparent that equivalent parts may be substituted for those shown and other changes can be made within the scope of the present invention as defined by the appended claims.

What is claimed is:

1. A high density rack mount computer server comprising:
a server serial port securely mounted on computer server for providing electrical connections to the server; and
a display serial port securely mounted on a display panel capable of displaying information from the server, said display serial port providing electrical connections to said display panel,
wherein, when the display serial port is plugged into the server serial port the display panel is mechanically supported.

2. The server of claim 1 wherein the server serial port is mounted on a front surface of the server.

3. The server of claim 1 wherein the display serial port is mounted on a back surface of the server.

4. The server of claim 1, wherein the serial ports operate in RS 232 protocol.

5. The server of claim 1, wherein when the display serial port is plugged into the server serial port, the display panel is mechanically supported in a position where the display is visible to a user.

6. The server of claim 5, wherein the display is supported in front of a front surface of the server.

7. The apparatus of claim 1 wherein the length and width dimensions of the display panel are less than the length and width dimensions of the front surface of the computer server.

8. The apparatus of claim 1, further including:
at least one push button mounted on said display panel and connected to said display serial port to allow a user to send information to, or access information from, the server.

9. A method for providing a user interface for a headless rack mounted computer server comprising:
providing a server serial port securely mounted on a computer server for providing information;
providing a display serial port securely mounted on a display panel capable of displaying information from the server;
plugging said display serial port into said server serial port whereby said display is mechanically supported and electrically connected to the server such that server information may be displayed on said display panel.

10. The method of claim 9 wherein said server serial port is mounted on a front surface of said server.

11. The method of claim 9 wherein said panel serial port is mounted on a back surface of said panel.

12. The method of claim 9 wherein the serial ports operate in RS 232 protocol.

13. The method of claim 9 wherein said display panel includes one or more pushbuttons mounted on said display panel and connected to said server through said display serial port, further including using said push buttons to send information to, or access information from, the server.

14. The method of claim 9, wherein when the display serial port is plugged into the server serial port, the display panel is mechanically supported in a position where the display is visible to a user.

15. The method of claim 9, wherein the display is supported in front of the front surface of the server.

16. A method for loading software onto a headless rack mounted computer server having preboot execution environment software and an Internet connection comprising:
providing a server serial port on a computer server for providing a communication interface with the server;
providing a display serial port and a pushbutton on a display panel capable of displaying information from the server;
plugging said display serial port into said server serial port whereby said display is mechanically supported and electrically connect to display information from the server on said display panel,
displaying a list of software options on the display panel, and
using said push button to select software to be loaded onto said server.

17. The method of claim 16 wherein said server serial port is mounted on a front surface of said server.

18. The method of claim 17 wherein said panel serial port is mounted on a back surface of said panel.

19. The method of claim 16 wherein, when said display port serial port is plugged into the server serial port, the display panel is mechanically supported in a position where the display is visible to a user.

20. The method of claim 19 wherein said display panel is supported in front of a front surface of said server.

21. The method of claim 9 wherein the serial ports operate in RS 232 protocol.
